(19) United States
(12) Patent Application Publication
(10) Pub. No.: US 2025/0254262 A1
(43) Pub. Date: Aug. 7, 2025

(54) PROMPTER SYSTEM

(71) Applicant: NIHON VIDEO SYSTEM CO., LTD., Tsushima-shi (JP)

(72) Inventors: Kentaro HASHIGUCHI, Tsushima-shi (JP); Akikazu HASHIGUCHI, Tsushima-shi (JP)

(73) Assignee: NIHON VIDEO SYSTEM CO., LTD., Tsushima-shi (JP)

(21) Appl. No.: 19/024,682

(22) Filed: Jan. 16, 2025

(30) Foreign Application Priority Data
Feb. 6, 2024 (JP) 2024-016457

(51) Int. Cl. H04N 5/222; G06T 7/20; H04N 23/611; H04N 23/695

(52) U.S. Cl. CPC H04N 5/2222; G06T 7/20; H04N 23/611; H04N 23/695

(57) ABSTRACT

A prompter system compatible with a camera having pan, tilt, and zoom functions is invented. According to the present invention, a prompter system compatible with a camera having pan, tilt, and zoom functions is constructed by storing a camera having pan, tilt, and zoom functions inside a camera attaching adapter and combining it with a prompter body.

### CROSS-REFERENCE TO RELATED APPLICATION

This application claims priority to Japanese Patent Application No. 2024-016457, filed Feb. 6, 2024, which is incorporated by reference in its entirety for all purposes.

### TECHNICAL FIELD

The present invention relates to a prompter system used for broadcasting and general filming.

### BACKGROUND ART

A prompter is a system used in broadcasting and general filming. A half mirror or glass is attached to a front of a camera lens, and a liquid crystal displaying an inverted video signal is attached to a bottom of the half mirror or glass. An image displayed to the liquid crystal is reflected by the half mirror or glass, delivering information to a subject. The subject can see the information added to the video signal while looking straight at the camera lens, allowing for stable recording.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

### Technical Problem

With a prompter system, the subject's gaze is directed toward the camera lens, but the information is visually confirmed through the video signal, etc. provided to the prompter system, allowing for stable recording.

Traditionally, a camera used in prompter systems, such as a shoulder camera and a handheld camera, has a shape where a lens part protrudes forward. Because the lens part protrudes, the prompter systems can be easily attached by covering only the lens part. However, in recent years, there has been an increase in cameras that pan, tilt, and zoom on their own, and these cameras have lenses built into them and have a shape of a dome. This made it difficult to attach the cameras to the prompter systems, and the improvements was necessary. In addition, when a camera that pans, tilts, and zooms is attached to the prompter system, the pan and tilt functions are not fully reflected in the prompter system. As a result, the improvement was also necessary here.

In light of the above circumstances, the present invention has been filed in order to improve convenience and comfort.

### Solution to Problem

According to the present invention, the following inventions are provided.

[1] A prompter system for broadcasting, comprising an attaching mechanism for attaching a camera having pan, tilt and zoom functions to the prompter system.
[2] The prompter system of [1], wherein the attaching mechanism attaches the camera using a hook-and-loop fastener.
[3] The prompter system of [1] or [2], wherein an angle component attached between the attaching mechanism and the prompter system adjusts a mirror angle of the prompter system.
[4] The prompter system of any one of [1] to [3], wherein a different type of camera having pan, tilt and zoom functions is used by using a component that adjusts a height of the attaching mechanism.
[5] The prompter system of any one of [1] to [4], wherein a personal computer that displays a manuscript is built into the attaching mechanism or the prompter system, and the manuscript is displayed on the attaching mechanism for attaching a camera having pan, tilt and zoom functions or the prompter system.
[6] The prompter system of any one of [1] to [5], wherein an adapter for an optical transmission device is built into the attaching mechanism or the prompter system, and an optical communication including some or all of a control signal, a tally signal, a camera signal, and a camera control signal of a camera having pan, tilt, and zoom functions is able to be performed with a base station of the optical transmission device.
[7] The prompter system of [6], wherein it is able to be used as a system of the camera having pan, tilt and zoom functions camera and the optical transmission device, by removing the prompter system.
[8] The prompter system of any one of [1] to [7], wherein a face recognition sensor is attached to the attaching mechanism or the prompter system, and when an electric pan head is attached, a subject captured by the camera is tracked.
[9] The prompter system of any one of [1] to [8], wherein a balance adapter capable of adjusting a center of gravity of the entire prompter system is attached to the attaching mechanism or the prompter system.
[10] The prompter system of any one of [1] to [9], wherein a slidable adapter is attached to the attaching mechanism, and the slidable adapter is able to assist in attaching a camera having pan, tilt and zoom functions.
[11] A prompter system for broadcasting, comprising
an attaching mechanism for attaching a camera having pan, tilt and zoom functions to the prompter system;
a half mirror or glass unit, wherein
the attaching mechanism has a shape of a box that covers the camera, and
the attaching mechanism is attached to the half mirror or glass unit using a hook-and-loop fastener.
   [12] The prompter system of [11], wherein
the camera has a shape of a dome.
   [13] The prompter system of or [12], further comprising an angle component attached between the attaching mechanism and the prompter system and capable of adjusting a mirror angle of the prompter system.
   [14] The prompter system of any one of to [13], further comprising a component capable of adjusting a height of the camera so that a different type of camera having pan, tilt and zoom functions can be used.
   [15] The prompter system of any one of to [14], wherein
a personal computer that displays a manuscript is built into the attaching mechanism or the prompter system, and
the manuscript is displayed on the half mirror or glass unit.
   [16] The prompter system of any one of to [15], wherein
an adapter for an optical transmission device is built into the attaching mechanism or the prompter system, and
an optical communication including some or all of a control signal, a tally signal, a camera signal, and a camera control signal of a camera having pan, tilt, and zoom functions is able to be performed with a base station of the optical transmission device.
   [17] The prompter system of any one of to [16], wherein
a face recognition sensor is attached to the attaching mechanism or the prompter system, and
when an electric pan head is attached, a subject captured by the camera is tracked.
   [18] The prompter system of any one of to [17], wherein
the prompter system comprises a liquid crystal unit that displays an image and a base where the attaching mechanism is placed,
a balance adapter where the liquid crystal unit and the base are able to be attached is attached, and
the balance adapter is capable of adjusting a center of gravity of the liquid crystal unit and the base.
   [19] The prompter system of any one of to [18], wherein
a slidable adapter is attached to the attaching mechanism, and
the slidable adapter is able to assist in attaching a camera having pan, tilt and zoom functions.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 shows a prompter system according to a first embodiment of the present invention.

FIG. 2 shows a prompter system according to a second embodiment of the present invention.

FIG. 3 shows a prompter system according to a third embodiment of the present invention.

### DETAILED DESCRIPTION

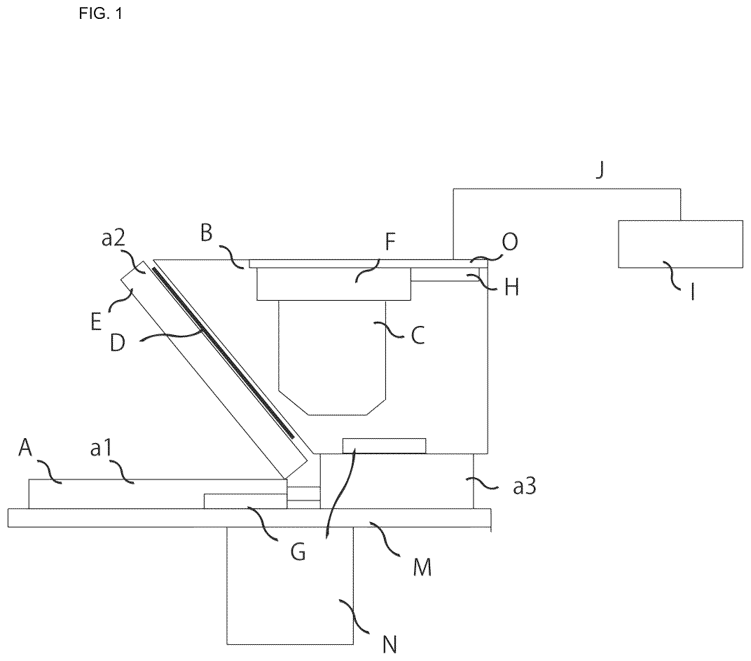

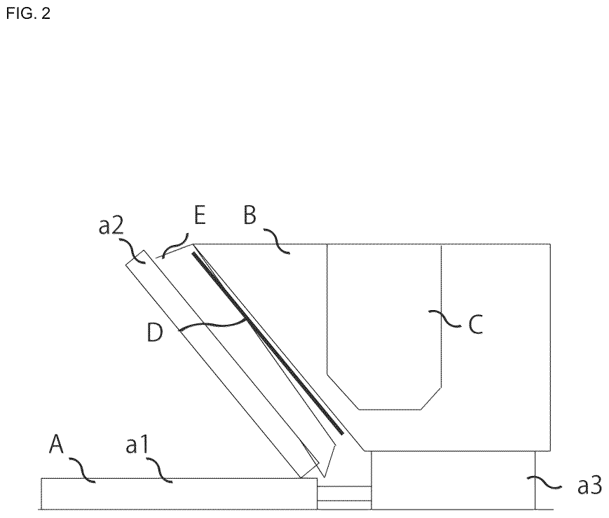

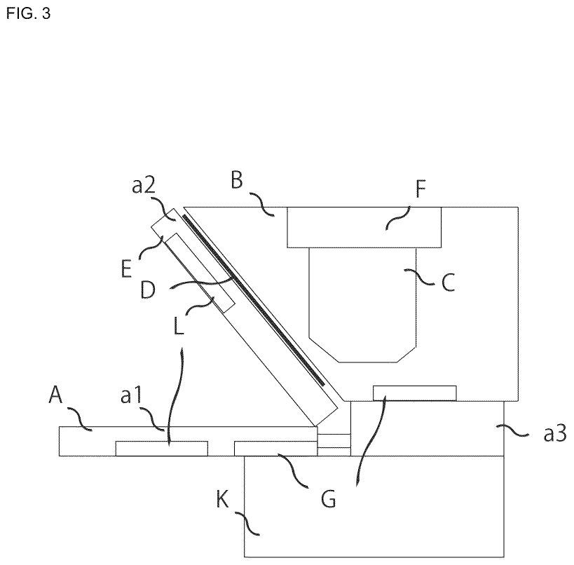

Hereinafter, first to third embodiments of the present invention will be described with reference to FIGS. 1 to 3.

A prompter system of this embodiment uses a camera attaching adapter B to attach a prompter body A and a camera C having pan, tilt and zoom functions. The camera attaching adapter B has a shape of a box that covers the entire camera C having pan, tilt and zoom functions.

### Description of Claim 1

The prompter system of this embodiment uses the camera attaching adapter B to attach the prompter body A and the camera C having pan, tilt and zoom functions. The camera attaching adapter B and the prompter half mirror or glass unit a2 are attached using a hook-and-loop fastener D.

### Description of Claim 2

The prompter system of this embodiment uses the camera attaching adapter B to attach the prompter body A and the camera C having pan, tilt and zoom functions. The camera attaching adapter B and the prompter half mirror or glass unit a2 are attached using a hook-and-loop fastener D. In addition, by attaching an angle adjustment adapter E between the camera attaching adapter B and the prompter half mirror or glass unit a2, it is possible to change an angle of the prompter half mirror or glass unit a2.

### Description of Claim 3

The prompter system of this embodiment uses the camera attaching adapter B to attach the prompter body A and the camera C having pan, tilt and zoom functions. A height adjustment adapter F is attached inside the camera attaching adapter B. This allows a height of the camera C to be adjusted, and makes it compatible with an optical axis of a lens and other model, etc.

### Description of Claim 4

The prompter system of this embodiment uses the camera attaching adapter B to attach the prompter body A and the camera C having pan, tilt and zoom functions. A personal computer function G is built into a prompter liquid crystal unit a1 or the camera attaching adapter B. The personal computer function G displays data from a manuscript on the prompter liquid crystal unit al, which is reflected and projected on the prompter half mirror or glass unit a2, thereby realizing the prompter system.

### Description of Claim 5

The prompter system of this embodiment uses the camera attaching adapter B to attach the prompter body A and the camera C having pan, tilt and zoom functions. An optical transmission adapter H is inserted inside the camera attaching adapter B, and an optical communication is performed with an optical transmission base station I via an optical cable J.

### Description of Claim 6

The prompter system of this embodiment performs the optical communication with the optical transmission base station I via the optical cable J even when the optical transmission adapter H is not built into the camera attaching adapter B.

### Description of Claim 7

The prompter system of this embodiment uses the camera attaching adapter B to attach the prompter body A and the camera C having pan, tilt and zoom functions. A face recognition sensor L is attached to the prompter liquid crystal unit a1 or the prompter half mirror or glass unit a2. An electric pan head K is operated by the face recognition sensor L to track a subject.

### Description of Claim 8

The prompter system of this embodiment uses the camera attaching adapter B to attach the prompter body A and the camera C having pan, tilt and zoom functions. A balance plate M capable of attaching from the prompter liquid crystal unit al to the prompter base a3 is attached. When a tripod N is attached, the balance plate M ensures that the center of the whole system is in harmony.

### Description of Claim 9

The prompter system of this embodiment uses the camera attaching adapter B to attach the prompter body A and the camera C having pan, tilt and zoom functions. Attaching a slide adapter O to the inside of the camera attaching adapter B assists in attaching the camera C having pan, tilt and zoom functions or the height adjustment adapter F from outside the camera attaching adapter B.

### Description of Claim 10

### Reference Signs List

A: prompter body, a1: prompter liquid crystal unit, a2: prompter half mirror or glass unit, a3: prompter base, B: camera attaching adapter, C: camera having pan, tilt and zoom functions, D: hook-and-loop fastener, E: angle adjustment adapter, F: height adjustment adapter, G: personal computer function, H: optical transmission adapter, I: optical transmission base station, J: optical cable, K: electric pan head, L: face recognition sensor, M: balance plate, N: tripod, O: slide adapter.

While illustrative embodiments have been illustrated and described, it will be appreciated that various changes can be made therein without departing from the spirit and scope of the invention.

1. A prompter system for broadcasting, comprising
an attaching mechanism for attaching a camera having pan, tilt and zoom functions to the prompter system.

2. The prompter system of claim 1, wherein
the attaching mechanism attaches the camera using a hook-and-loop fastener.

3. The prompter system of claim 1, further comprising an angle component attached between the attaching mechanism and the prompter system and capable of adjusting a mirror angle of the prompter system.

4. The prompter system of claim 1, further comprising a component capable of adjusting a height of the attaching mechanism so that a different type of camera having pan, tilt and zoom functions can be used.

5. The prompter system of claim 1, wherein
a personal computer that displays a manuscript is built into the attaching mechanism or the prompter system, and
the manuscript is displayed on the attaching mechanism for attaching a camera having pan, tilt and zoom functions or the prompter system.

6. The prompter system of claim 1, wherein
an adapter for an optical transmission device is built into the attaching mechanism or the prompter system, and
an optical communication including some or all of a control signal, a tally signal, a camera signal, and a camera control signal of a camera having pan, tilt, and zoom functions is able to be performed with a base station of the optical transmission device.

7. The prompter system of claim 6, wherein
it is able to be used as a system of the camera having pan, tilt and zoom functions camera and the optical transmission device, by removing the prompter system.

8. The prompter system of claim 1, wherein
a face recognition sensor is attached to the attaching mechanism or the prompter system, and
when an electric pan head is attached, a subject captured by the camera is tracked.

9. The prompter system of claim 1, wherein
a balance adapter capable of adjusting a center of gravity of the entire prompter system is attached to the attaching mechanism or the prompter system.

10. The prompter system of claim 1, wherein
a slidable adapter is attached to the attaching mechanism, and
the slidable adapter is able to assist in attaching a camera having pan, tilt and zoom functions.

11. A prompter system for broadcasting, comprising
an attaching mechanism for attaching a camera having pan, tilt and zoom functions to the prompter system;
a half mirror or glass unit, wherein
the attaching mechanism has a shape of a box that covers the camera, and
the attaching mechanism is attached to the half mirror or glass unit using a hook-and-loop fastener.

12. The prompter system of claim 11, wherein
the camera has a shape of a dome.

13. The prompter system of claim 11, further comprising an angle component attached between the attaching mechanism and the prompter system and capable of adjusting a mirror angle of the prompter system.

14. The prompter system of claim 11, further comprising a component capable of adjusting a height of the camera so that a different type of camera having pan, tilt and zoom functions can be used.

15. The prompter system of claim 11, wherein
a personal computer that displays a manuscript is built into the attaching mechanism or the prompter system, and
the manuscript is displayed on the half mirror or glass unit.

16. The prompter system of claim 11, wherein
an adapter for an optical transmission device is built into the attaching mechanism or the prompter system, and
an optical communication including some or all of a control signal, a tally signal, a camera signal, and a camera control signal of a camera having pan, tilt, and zoom functions is able to be performed with a base station of the optical transmission device.

17. The prompter system of claim 11, wherein
a face recognition sensor is attached to the attaching mechanism or the prompter system, and
when an electric pan head is attached, a subject captured by the camera is tracked.

18. The prompter system of claim 11, wherein
the prompter system comprises a liquid crystal unit that displays an image and a base where the attaching mechanism is placed,
a balance adapter where the liquid crystal unit and the base are able to be attached is attached, and
the balance adapter is capable of adjusting a center of gravity of the liquid crystal unit and the base.

19. The prompter system of claim 11, wherein
a slidable adapter is attached to the attaching mechanism, and
the slidable adapter is able to assist in attaching a camera having pan, tilt and zoom functions.
